(19) United States
(12) Patent Application Publication
(10) Pub. No.: US 2018/0033158 A1
(43) Pub. Date: Feb. 1, 2018

(54) LOCATION METHOD AND SYSTEM

(71) Applicant: CINIME ASIA PACIFIC PTE. LTD., Singapore (SG)

(72) Inventor: Tom CAMPBELL, Singapore (SG)

(21) Appl. No.: 15/657,444

(22) Filed: Jul. 24, 2017

Related U.S. Application Data
(60) Provisional application No. 62/367,255, filed on Jul. 27, 2016.

(51) Int. Cl. G06T 7/70; A63F 13/213; A63F 13/216; A63F 13/92; G06K 9/62; G06F 3/0488

(52) U.S. Cl. CPC G06T 7/70; G06K 9/6202; G06F 3/0488; A63F 13/216; A63F 13/92; A63F 13/213

(57) ABSTRACT

The present invention relates to a method of determining the location of a portable computing device within a physical area. The method includes a camera on the portable computing device capturing at least part of an image displayed within the physical area, matching the captured image to a database of pre-stored image information, utilising the matched pre-stored image information to calculate a virtual camera position and orientation from the captured image and generating the location of the portable computing device utilising the virtual camera position and orientation. A location system and software are also disclosed.

### FIELD OF INVENTION

The present invention is in the field of location detection. More particularly, but not exclusively, the present invention relates to locating a portable computing device within a physical area.

### BACKGROUND

It can be useful to determine the location of a portable computing device to provide additional services or functionality to the user, or to provide the location of the user to various services.

There are a number of existing systems for determining the location of a portable computing device. Many portable computing devices, such as smart-phones, include GPS (Global Positioning System) modules. The operation of GPS is well known. Signals received at the GPS module from a plurality of orbiting satellites are utilised to triangulate the location of the device. One disadvantage of GPS is that the GPS module must be able to receive the signals from the satellites clearly and without reflection. Furthermore, the accuracy of a GPS signal in use is typically within 5 metres.

One modification to the GPS system is assisted GPS which utilises signals from local cellular towers to improve the accuracy and speed of the location determination. However, this requires cellular coverage and still requires the ability to receive signals from the GPS satellites.

It would be useful to determine the location of a user's device more accurately. Particularly for applications within stadiums, cinemas, auditoriums, or other physical areas where accuracy is required but where GPS signals may be unreliable, distorted, or unavailable.

One method for determining the location of a user's device within a seated auditorium, such as a stadium or cinema, is by utilising the user's seat number and a look up table to determine the user's physical position. This method requires the seating layouts of all the auditoriums to be known and may also require the user to enter their seat number.

Aside from location, it can be helpful to determine the orientation of a portable computing device. At present, this is commonly performed by utilising the device's compass, accelerometer, and gyroscope modules. One disadvantage of these techniques is that the modules need to be frequently recalibrated by the user to provide accurate data.

Another method for determining the location of a user is utilised by gaming consoles such as the Xbox Kinect. The Xbox Kinect uses an IR (Infrared) projector and camera to form a 3D assessment of the location of players. A disadvantage of the Xbox Kinect is that it only operates within a few metres and requires specialist hardware.

There is a desire for an improved method for locating a portable computing device within a physical area.

It is an object of the present invention to provide a method and system for locating a portable computing device within a physical area which overcomes the disadvantages of the prior art, or at least provides a useful alternative.

### SUMMARY OF INVENTION

According to a first aspect of the invention there is provided a method of determining the location of a portable computing device within a physical area, including:

a. a camera on the portable computing device capturing at least part of an image displayed within the physical area;

b. matching the captured image to a database of pre-stored image information;

c. utilising the matched pre-stored image information to calculate a virtual camera position and orientation from the captured image; and

d. generating the location of the portable computing device utilising the virtual camera position and orientation.

The location of the portable computing device may be relative to the location of the image. The location of the portable computing device relative to the location of the image may be calculated in units relative to at least one dimension of the image. When the physical size of the image is known to the portable computing device, the location of the portable computing device may be calculated in absolute units relative to the location of the image.

When the physical size of the image is known to the portable computing device and the physical location of the image is known to the portable computing device, both the physical size and physical location may be used to calculate the absolute location of the portable computing device.

The method may further include the step of generating the orientation of the portable computing device utilising the virtual camera position and orientation. The generated orientation may be relative to the orientation of the image or absolute.

The camera may successively capture a plurality of, at least, partial images and the plurality of partial images may be utilised to generate the location of the portable computing device. The plurality of images may be disposed at different locations within the physical area. The plurality of images may be disposed at different orientations within the physical area. Alternatively, the plurality of images may form a larger image at a single location within the physical area.

The generated location may be utilised by an application on the portable computing device. The application may be a game application. The application may receive input from a user of the portable computing device and the input may be validated at least based upon the generated location for the portable computing device. The image may be part of a video, the application may be synchronised with the video, and the input may be further validated based upon synchronisation within the video.

The portable computing device may interoperate with a plurality of portable computing devices for which locations have also been generated.

The image may be displayed by a video system on a screen. The screen may be an electronic screen. The video system may be a cinema projector system and the screen may be a cinema screen.

The physical area may be an auditorium.

According to a further aspect of the invention there is provided a system for determining the location of a portable computing device within a physical area, including:

a camera configured for capturing at least part of an image displayed within the physical area; and

at least one processor configured for matching the captured image to a database of pre-stored image information, utilising the matched pre-stored image information to calculate a virtual camera position and orientation from the captured image, and generating the location of the portable computing device utilising the virtual camera position and orientation.

According to a further aspect of the invention there is provided a portable computing device including:

a camera configured for capturing at least part of an image displayed within the physical area; and

at least one processor configured for matching the captured image to a database of pre-stored image information, utilising the matched pre-stored image information to calculate a virtual camera position and orientation from the captured image, and generating the location of the portable computing device utilising the virtual camera position and orientation.

According to a further aspect of the invention there is provided a computer program, which when executed by a processor of a portable computing device cause the device to:

capture, via a camera, at least part of an image displayed within the physical area; match the captured image to a database of pre-stored image information; calculate a virtual camera position and orientation from the captured image utilising the matched pre-stored image information; and

generate the location of the portable computing device utilising the virtual camera position and orientation.

Other aspects of the invention are described within the claims.

### BRIEF DESCRIPTION OF THE DRAWINGS

Embodiments of the invention will now be described, by way of example only, with reference to the accompanying drawings in which:

FIG. 1a: shows a block diagram illustrating a location system in accordance with an embodiment of the invention;

FIG. 1b: shows a block diagram illustrating a location system in accordance with an alternative embodiment of the invention;

FIG. 2: shows a flow diagram illustrating a method in accordance with an embodiment of the invention;

FIGS. 3a, 3b, and 3c:
show diagrams illustrating a method in accordance with an embodiment of the invention used within a cinema auditorium;

FIG. 4: shows a diagram illustrating a virtual space for a game using a method in accordance with an embodiment of the invention;

FIGS. 5a and 5b:
show screenshots illustrating a game using a method in accordance with an embodiment of the invention;

FIG. 6: shows a block diagram of a location system in accordance with an embodiment of the invention;

FIGS. 7a and 7b:
show diagrams illustrating a system in accordance with an embodiment of the invention used within a stadium;

FIGS. 8a and 8b:
show diagrams illustrating a method in accordance with an embodiment of the invention used to provide a light show; and

FIG. 9: shows example images used within a location system in accordance with an embodiment of the invention.

### DETAILED DESCRIPTION OF PREFERRED EMBODIMENTS

The present invention provides a method and system for determining the location of a portable computing device.

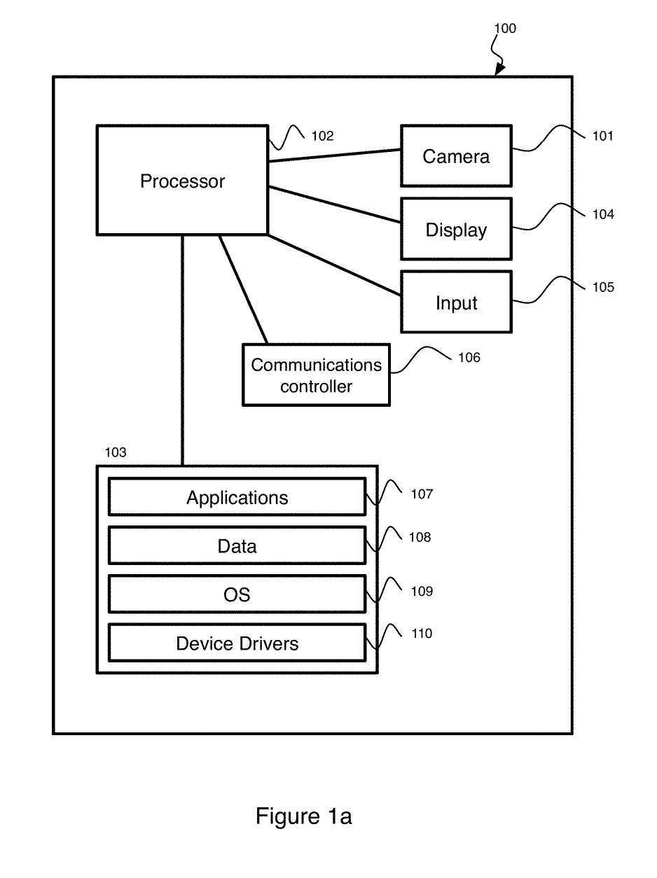

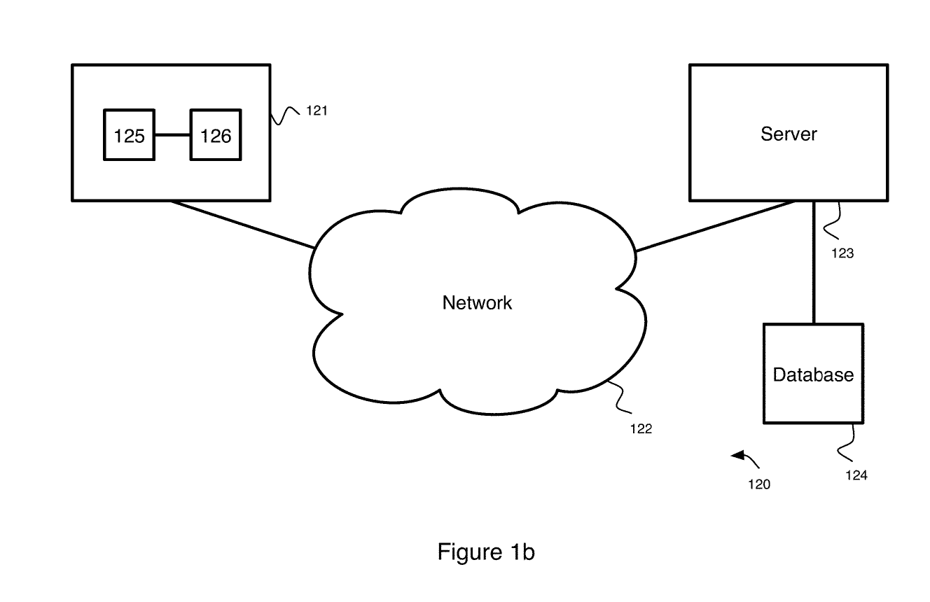

In FIG. 1a, a system 100 for determining the location of a portable computing device in accordance with an embodiment of the invention is shown.

The system 100 may be a portable computing device 100 which may comprise a camera 101, a processor 102, and a memory 103.

The portable computing device 100 may be a mobile smart-phone, tablet, phablet, smart-watch, or single-purpose apparatus.

The portable computing device 100 may further comprise a display 104 and input 105 to provide additional functionality to the user or to provide convenient mobile computing/communications services.

The portable computing device 100 may further comprise a communications controller 106 to facilitate communications with a server and/or to facilitate convenient communications services.

The memory 103 may be configured for storing applications 107, data 108, an operating system 109, and device drivers 110 for interfacing with the hardware components (e.g. 101, 104, 105, and 106) of the portable computing device 100.

The camera 101 may be configured for capturing still images and/or video.

The processor 102 may be configured for matching digital images captured by the camera 101 to a pre-stored database of information for images. The memory 103 may be configured for storing the database of image information (at e.g. 108). The database of image information may be updated or downloaded from a server via the communications controller 106.

The processor 102 may be further configured for utilising the matched stored image to calculate a virtual camera position and orientation from the captured image.

The processor 102 may be further configured for generating the location of the portable computing device 100 using the virtual camera position and orientation.

The functionality of the processor 102 above may be controlled by one or more applications 107 stored in memory 103.

It will be appreciated that the functionality of the processor 102 may be performed by a plurality of processors in communication with one another. For example, a specialised image processor could be configured for matching the capturing images to the stored image information, and/or a graphical processing unit (GPU) could be configured for generating the virtual camera position and orientation.

In FIG. 1b, a system 120 for determining the location of a portable computing device 121 in accordance with an alternative embodiment of the invention is shown.

The system 120 may comprise a portable computing device 121, a communications network 122, a server 123, and a database 124.

The portable computing device 121 may include a camera 125 and communications controller 126.

The database 124 may be configured for pre-storing information for a plurality of images.

The camera 125 may be configured for capturing an image.

The communications controller 126 may be configured for transmitting the image to the server 123.

The server 123 may be configured for matching images received from the portable computing device 121 to the pre-stored database 124 of image information.

The server 123 may be further configured for utilising the matched stored image to calculate a virtual camera position and orientation from the captured image.

The server 123 may be further configured for generating the location of the portable computing device 121 using the virtual camera position and orientation.

The location of the portable computing device 121 may be transmitted back to the portable computing device 121 from the server 123.

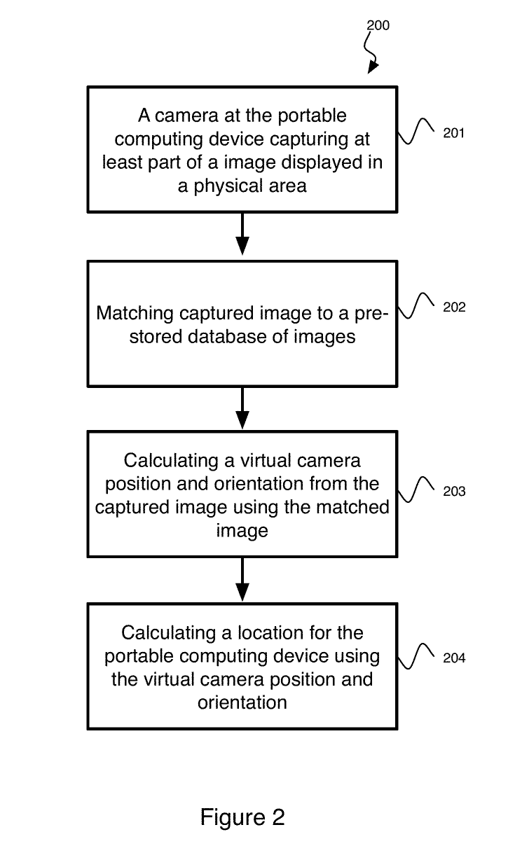

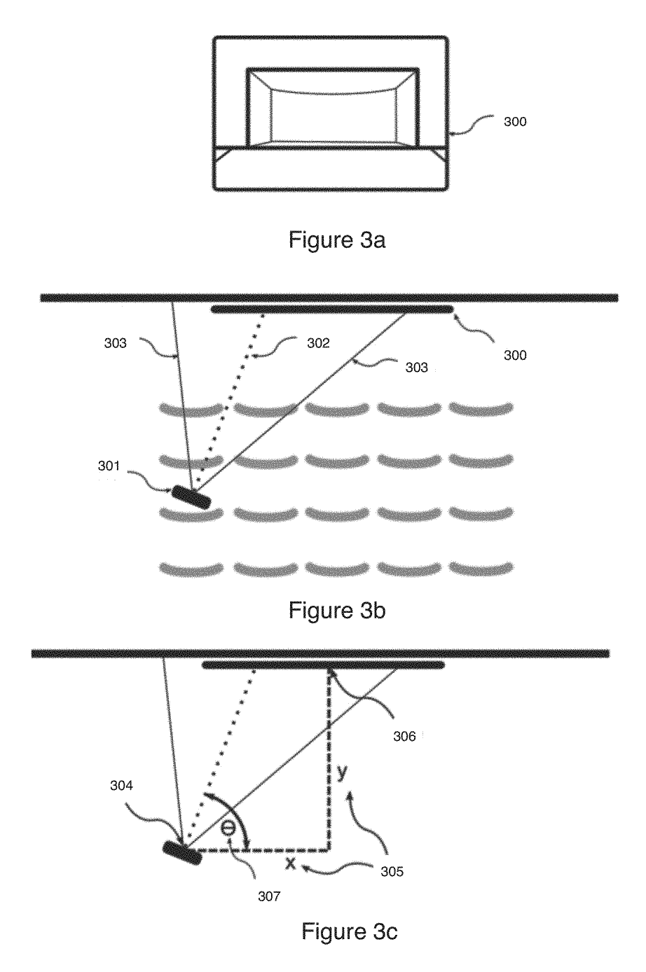

Referring to FIG. 2, a method 200 in accordance with an embodiment of the invention will be described.

In step 201, a camera at a portable computing device captures at least part of an image displayed in a physical area. The image may be displayed on a dynamic display such as an electronic video screen or projection screen, or the image may be displayed in a static format such as a printed form. The camera may capture the entire image or a part of the image. The image may form, in the physical display, with a plurality of further images a larger image or a sub-image of a larger image.

In step 202, the captured image may be matched to a database of pre-stored image information. This step may be performed by a processor, for example, at the portable computing device. The database may be stored in the memory of the portable computing device.

The pre-stored image information may include the displayed image, part of the displayed image, or a fingerprint of the displayed image or part of the displayed image, such as high contrast reference points. The pre-stored image information database may include information relating to a plurality of images. In one embodiment, some of the plurality of images form a larger image or sub-set of a larger image.

In step 203, a virtual camera position and orientation is calculated using the captured image and the matched image. This calculation may be performed by an augmented reality engine such as Vuforia™ or ARToolkit.

In step 204, the location of the portable computing device is calculated from the virtual camera position and orientation.

The location can be calculated as relative to the displayed image or as absolute if the location and size of the displayed image is known. If only the size of the displayed image is known, then the location may be calculated as relative to the displayed image in absolute units (e.g. 3 metres from the image in the physical area), otherwise the location may be calculated in relative units (e.g. 1.5x the height of the image away from the image in the physical area).

In one embodiment, the portable computing device captures a plurality of images and each image is matched to the pre-stored image information. The matched images are used to improve the accuracy of the calculation of the virtual camera position and orientation. The captured images may be sub-images of a larger image at the same physical location or may be disposed at different physical locations within the physical area.

In one embodiment, a plurality of portable computing devices within the same physical area captures, at least part of, images located at different physical locations.

The location of the portable computing device may be used within a single or multi-player game experience within the mobile device and/or in conjunction with the display, for example, where the display is a cinema display or other dynamic/video display.

The location of the portable computing device may be used to provide audio-visual experiences within stadiums and auditoriums, such as triggering visual or audio at mobile devices based upon location within the stadium or auditorium.

The orientation of the portable computing device may also be calculated from the virtual camera position and orientation.

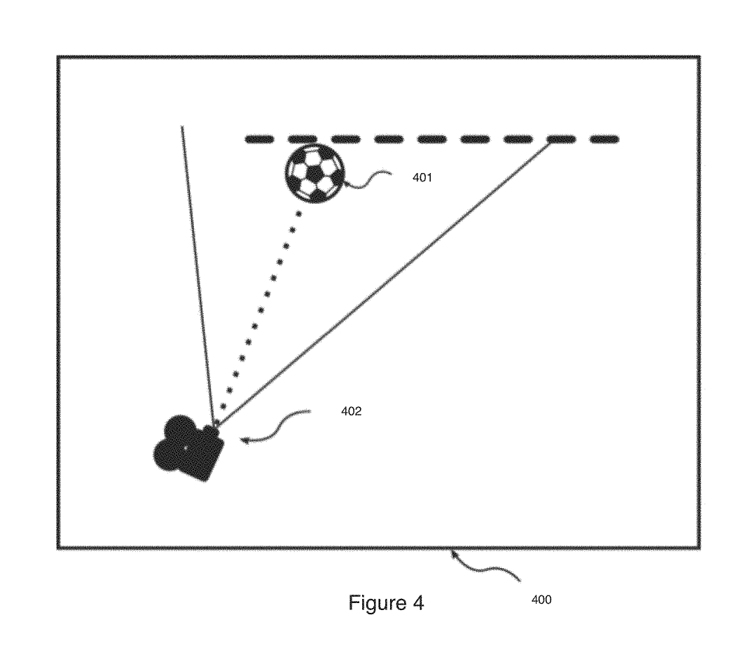

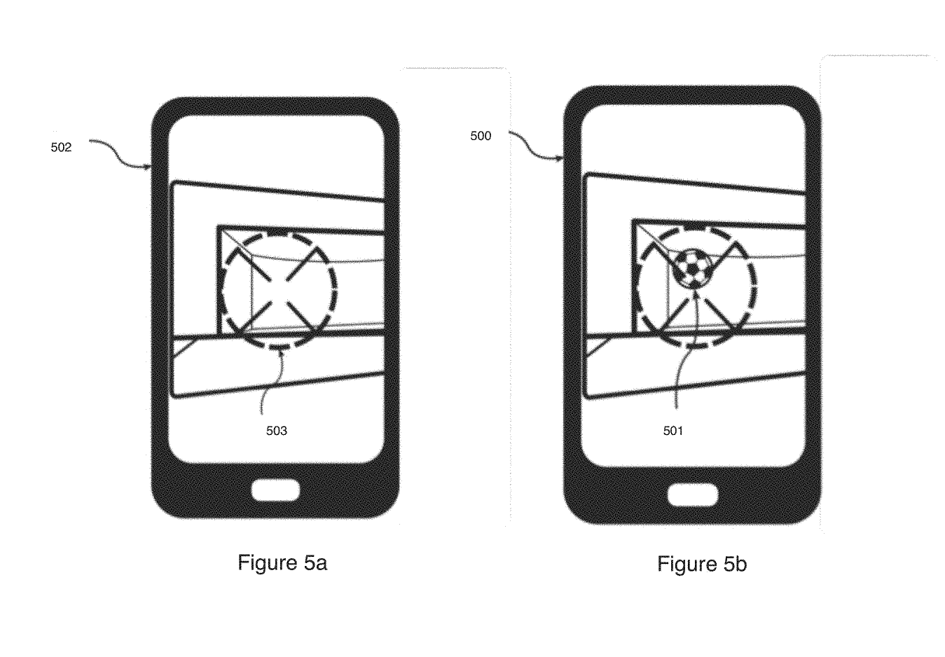

Referring to FIGS. 3a to 3c, 4, and 5a to 5b a method and system in accordance with an embodiment of the invention will be described.

This embodiment relates to use of a location method for playing a game within a cinema. It will be appreciated that this embodiment is exemplary and that the location method may be used for non-game purposes and/or in other environments.

The game is started using an audio trigger that is used to synchronise the game play at a plurality of mobile devices. Each mobile device is executing an app (mobile application) for capturing and processing images, and providing game-play. In alternative embodiments, the game may be started by a network trigger (i.e. a signal sent to the mobile device from a server or other mobile devices), or via a time-based trigger within the app at the mobile device.

A cinema screen 300 is used to show a reference image of a football goal that can be viewed by a user with their mobile device 301. The user aims 302 their mobile device 301 so that at least part of this reference image is visible (303 illustrates the field of view of the camera) to a camera on the mobile device 301. The mobile device 301 captures the (perhaps partial) image using the camera and uses standard image processing techniques to calculate where a virtual camera 304 needs to be placed to add virtual 3D graphical objects over the camera's view where they will align with real objects visible to the camera. This is called Augmented Reality (AR) and is a known technology. In this embodiment, this AR virtual camera positioning information is repurposed to calculate the position of the user of the mobile device 301 in the physical space around the reference image. In the case of a cinema, this can locate the user to a position in the auditorium.

An augmented reality recognition system within the app analyses the captured image to detect high contrast corner points (marker-less image targets). These points are then matched to the recognition data relating to the image in the database in the app taking any distortion based on viewing angle and image distance into account. The captured image can be recognised by matching a percentage of points and the viewing angle determined.

The recognition system generates a virtual camera position and orientation from the scanned image which is in relative coordinates from the screen. The position 304 is derived from the coordinates of the virtual camera which comprises its relative position 305 from the screen centre 306 and its orientation as yaw, pitch, and roll (illustrated in 2D by angle 307).

If the physical size of the image is known (e.g. the size of the cinema screen) then the position of the user relative to the image can be calculated in absolute units (e.g. 5 m from the screen, 2.5 m left of the centre, lm up from the bottom). If the image size is unknown then the position of the user relative to the image is calculated in relative units (e.g. 1.2× image width away, 20% right from the left edge of the screen).

This data is extracted and applied to a game on the mobile device 301 to define the position of the individual player relative to the screen in a virtual space 400.

For the football game, balls 401 can be shot from the position of the virtual player 402 into a goal that is the cinema screen 300. From the user's perspective at their mobile device 500 the ball 501 goes forward into the screen of the mobile device 500 towards the cinema screen 300.

The user aims by looking through the mobile device 502 to position sights 503 on the touch-screen on their device 502 and taps anywhere on the touch-screen or a displayed actuator/button on the touch-screen to launch a ball from their “seat” into the goal onscreen. The movement of the ball is displayed on the touch-screen of the mobile device 502 augmented over the camera view.

The game on the device 502 tracks the virtual ball to see if it lands in the virtual goal and scores the player appropriately. It also has a 3D model of the goal area so the ball can bounce off the posts and floor as it travels. The timing in movement of the internal model to the screen is synchronised using the audio trigger that started the game.

The mobile device 502 knows the position of the goalie using an internal model and the offset from the audio watermark code that started the game. Using this information the mobile device 502 can calculate if a goal is scored. Each device 502 tracks its own score.

At the end of the game the player's score is displayed on the mobile device's 502 screen.

The mobile phone app may also award different prizes dependent on their player's score.

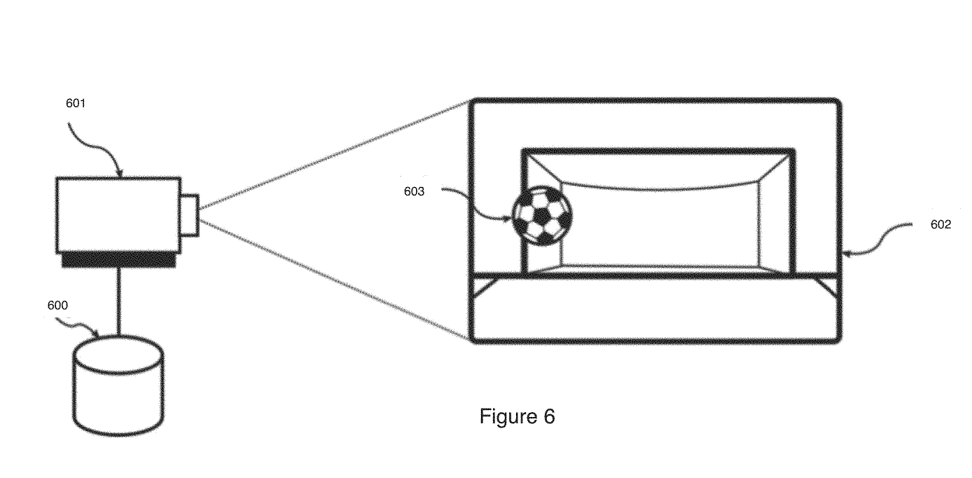

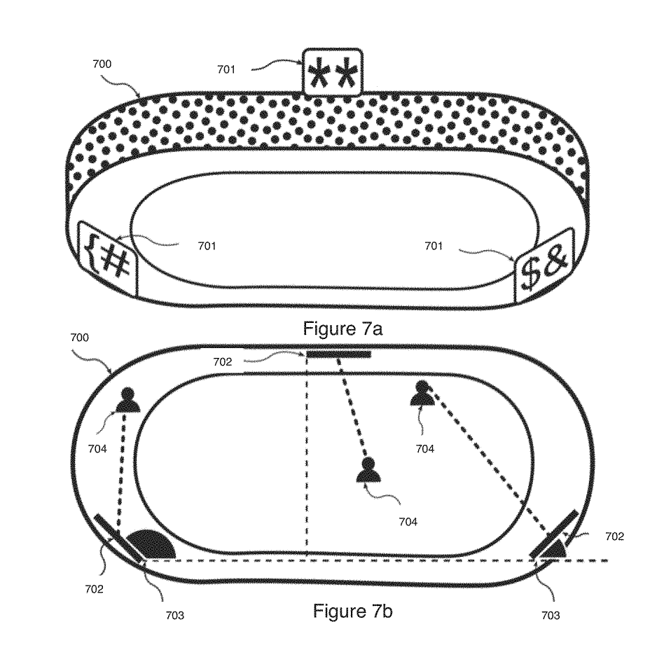

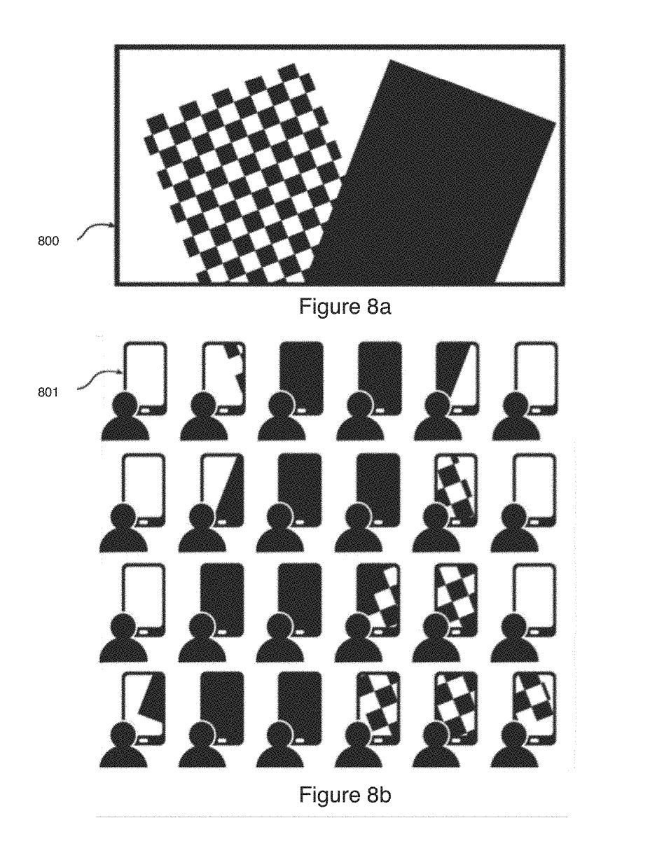

Referring to FIG. 6, a method and system in accordance with an embodiment of the invention will be described.

This embodiment comprises the same features as the embodiment described above with the addition of game-play information being transmitted back to a display device 600 connected to the projector 601 of a cinema screen 602 or another large display visible to the users of the mobile devices.

Each mobile device independently plays the game itself including its own model of where the goalie is at any time. The mobile device issues points (goals) and end of game prizes. The game play data sent to the display device 600 is the score for the user and where and when each ball is kicked. This data is broadcast to all mobile devices and the display device 600. No data needs to be sent back from the display device 600 to the mobile device.

The information from the mobile device is processed internally and the angle, position and direction of the ball are calculated. These are then sent to a display device 600 which controls the cinema projector 601 to show the result on the cinema screen 602. This displays the balls on the cinema screen 602.

The display device 600 connects to the mobile devices using, for example, a mesh or ad-hoc wifi network that is created by the mobile devices when they hear an audio watermark that is played at the beginning of the game. The virtual ball 603 is drawn into the goal view on the cinema screen 602 shown in the appropriate position as if it had come from the actual or relative position of the player in the auditorium.

The mobile devices know the position of the goalie at the time offset from the audio trigger so can automatically calculate if a goal is scored. Each device tracks its own score. At intervals the scores are broadcast over the mesh network and are used by the display device 600 to show a leader board on the cinema screen 602.

At the end of the game the player with the highest score is shown as the winner.

The mobile phone app may award different prizes dependent on 1st place, 2nd place 3rd place or their scores.

Referring to FIGS. 7a and 7b, a method in accordance with an embodiment of the invention will be described.

This embodiment relates to the use of images disposed at multiple locations within a physical area. This embodiment may be particularly suited for large spaces, such as stadiums.

For example, a stadium 700 can have a number of screens 701 around the space with unique reference images on them. FIG. 7b shows the three screens 702 and given relative positioning information 703 to each of the other screens from a reference screen the position of people looking at different screens with their mobile device 704 can be correlated. If a mobile device can see more than one screen the relative position of the different screens can be used to enhance the accuracy.

Referring to FIGS. 8a and 8b, a method in accordance with an embodiment of the invention will be described.

This embodiment relates to the use of the method described in relation to FIG. 2 for providing a synchronised light show.

A reference image is first shown on the screen 800 in FIG. 8a which gives each user's mobile phone their location relative to the screen. An audio or other wireless synchronisation device is used to synchronise all the phones in FIG. 8b with a video playing on the screen. Each phone (e.g. 801) then plays a portion of a video or light show on their respective phone, deciding which part to play by using the positional information derived from the initial image based position extraction and the audio watermark. All the phones are playing a visual sequence perfectly synchronised but they each only show a portion. The combined effect is a large video wall made from individual mobile devices automatically set up from the image based position system and a shared timing trigger.

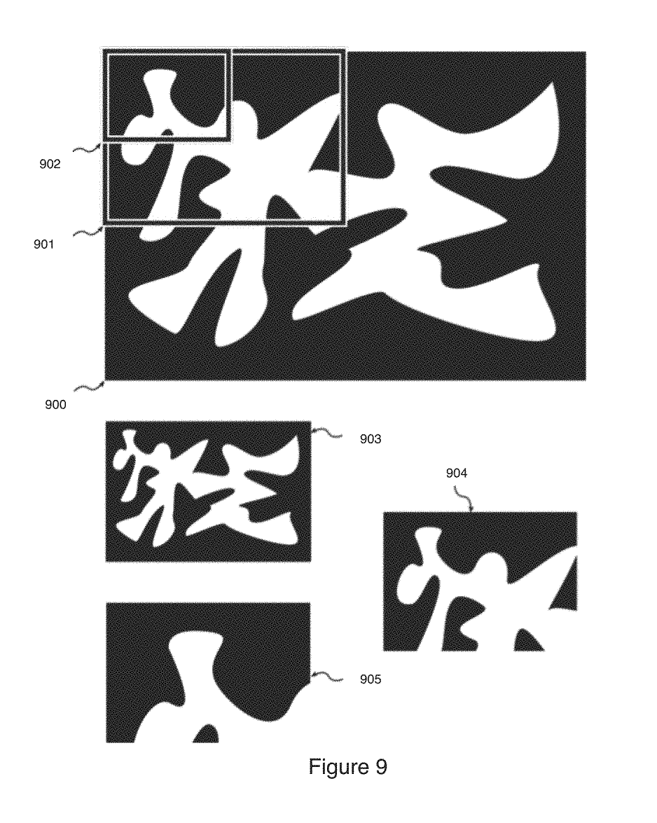

Referring to FIGS. 9a and 9d, a method in accordance with an embodiment of the invention will be described.

When large images are used for the positional tracking there may be a problem when users are too close to the image to match the captured portion of the image with the pre-stored image information.

To solve this problem, the main image 900 may be subdivided into smaller sections (901 and 902) and each section is used as an independent reference image. Each of these reference images 900, 901, and 902 can then be added to the list of recognisable images (903, 904 and 905 respectively) but each is also accompanied by their relative offset and size from the original image. So, for example, if the whole scan image 903 is 4 metres wide, the sub segment 904 is marked as being 2 metres wide and aligned to the top left of the original. So, in the example, the original image is quartered which generates 4 sub-images that the mobile device can scan and derive the user's position. These 4 sub images can then be sub divided again to get 16 sub-sub-images that can also be used to find the user's position.

Embodiments of the present invention can be used to provide a variety of different applications, including:

An Alien Spaceship Targeting Game

A target shooting game based on alien space ships flying across the big screen that can be shot, damaged and destroyed by players using their phones' screen/camera as targeting crosshairs. Each player who successfully targets an alien ship receives points for damaging it and extra points if it explodes while they have it in their gun sights.

Phone Screen Lighting Effects

To give an immersive effect to a high impact cinema advert (or other interactive experience), the big screen can be extended into the audience onto user's phone screens. For example, an on-screen explosion on the left of the screen could light up phone screens on the left of the auditorium with red/orange synchronized with the explosion. Or, for example, when a ship is sinking on screen then phones' screens could turn blue/green starting from the front row moving backwards to show a subtle lighting effect of the cinema filling with water. This can also be used in a stadium to provide lighting effects that could be triggered by audio watermarks.

A potential advantage of some embodiments of the present invention is that the location of a device can be determined without deploying specialist hardware within a physical area and within environments where external signal transmissions from, for example, positioning satellites or cellular networks might be impeded or degraded. A further potential advantage of some embodiments of the present invention is that fast and accurate location and/or orientation determination for a portable device can be used to provide combined virtual/physical world interactive possibilities for the user of the portable device.

While the present invention has been illustrated by the description of the embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details, representative apparatus and method, and illustrative examples shown and described.

Accordingly, departures may be made from such details without departure from the spirit or scope of applicant's general inventive concept.

1. A method of determining the location of a portable computing device within a physical area, including:
a. a camera on the portable computing device capturing at least part of an image displayed within the physical area;
b. matching the captured image to a database of pre-stored image information;
c. utilising the matched pre-stored image information to calculate a virtual camera position and orientation from the captured image; and
d. generating the location of the portable computing device utilising the virtual camera position and orientation.

2. A method as claimed in claim 1, wherein the location of the portable computing device is relative to the location of the image.

3. A method as claimed in claim 2, wherein the location of the portable computing device relative to the location of the image is calculated in units relative to at least one dimension of the image.

4. A method as claimed in claim 2, wherein the physical size of the image is known to the portable computing device and the location of the portable computing device is calculated in absolute units relative to the location of the image.

5. A method as claimed in claim 1, wherein the physical size of the image is known to the portable computing device and the physical location of the image is known to the portable computing device, and both the physical size and the physical location are used to calculate the absolute location of the portable computing device.

6. A method as claimed in claim 1, further including:
generating the orientation of the portable computing device utilising the virtual camera position and orientation.

7. A method as claimed in claim 6, wherein the orientation is relative to the orientation of the image.

8. A method as claimed in claim 6, wherein the orientation is absolute.

9. A method as claimed in claim 1, wherein the camera successively captures a plurality of, at least, partial images and wherein the plurality of partial images are utilised to generate the location of the portable computing device.

10. A method as claimed in claim 9, wherein the plurality of images are disposed at different locations within the physical area.

11. A method as claimed in claim 9, wherein the plurality of images are disposed at different orientations within the physical area.

12. A method as claimed in claim 9, wherein the plurality of images form a larger image at a single location within the physical area.

13. A method as claimed in claim 1, wherein the generated location is utilised by an application on the portable computing device.

14. A method as claimed in claim 13, wherein the application is a game application.

15. A method as claimed in claim 13, wherein the application receives input from a user of the portable computing device and wherein the input is validated at least based upon the generated location for the portable computing device.

16. A method as claimed in claim 15, wherein the image is part of a video, the application is synchronised with the video, and the input is further validated based upon synchronisation within the video.

17. A method as claimed in claim 1, wherein the portable computing device interoperates with a plurality of portable computing devices for which locations have also been generated.

18. A method as claimed in claim 1, wherein the image is displayed by a video system on a screen.

19. A method as claimed in claim 18, wherein the screen is an electronic screen.

20. A method as claimed in claim 18, wherein the video system is a cinema projector system and the screen is a cinema screen.

21. A method as claimed in claim 1, wherein the physical area is an auditorium.

22. A system for determining the location of a portable computing device within a physical area, including:
a camera configured for capturing at least part of an image displayed within the physical area; and
at least one processor configured for matching the captured image to a database of pre-stored image information, utilising the matched pre-stored image information to calculate a virtual camera position and orientation from the captured image, and generating the location of the portable computing device utilising the virtual camera position and orientation.

23. A computer readable medium configured for storing a computer program, which when executed by a processor of a portable computing device cause the device to:
capture, via a camera, at least part of an image displayed within the physical area;
match the captured image to a database of pre-stored image information;
calculate a virtual camera position and orientation from the captured image utilising the matched pre-stored image information; and
generate the location of the portable computing device utilising the virtual camera position and orientation.
